(19) United States
(12) Patent Application Publication
(10) Pub. No.: US 2022/0391223 A1
(43) Pub. Date: Dec. 8, 2022

(54) ADDING EXPRESSIVENESS TO PLUGIN EXTENSIONS USING INTEGRATION WITH OPERATORS

(71) Applicant: RED HAT, INC., Raleigh, NC (US)

(72) Inventors: Marcel Apfelbaum, Afula (IL); Aviel Yosef, Ra'anana (IL)

(21) Appl. No.: 17/341,671

(22) Filed: Jun. 8, 2021

(51) Int. Cl. G06F 9/445; G06F 8/61

(52) U.S. Cl. CPC G06F 9/44526; G06F 9/44505; G06F 9/44547; G06F 8/63

(57) ABSTRACT

A query for available plugin extensions is received from a client device. A request for operator images including plugin extensions is transmitted to a repository including multiple operator images, wherein each of the operator images includes corresponding metadata identifying the plugin extensions. Identifications of the operator images including the plugin extensions and the corresponding metadata identifying the plugin extensions are received from the repository. A listing of the plugin extensions is transmitted to the client device.

### TECHNICAL FIELD

Aspects of the present disclosure relate to container-orchestration systems, and more particularly, to adding expressiveness to plugin extensions using integration with operators.

### BACKGROUND

A container-orchestration system may automate many of the manual processes involved in deploying, managing, and scaling containerized applications. For example, a container-orchestration system for developing and running containerized applications may allow applications and the data centers that support them to expand from just a few machines and applications to thousands of machines that serve millions of clients. Container-orchestration systems may provide an image-based deployment module for creating containers and may store one or more image files for creating container instances. Many application instances can be running in containers on a single host without visibility into each other's processes, files, network, and so on. Each container may provide a single function (often called a “service”) or component of an application, such as a web server or a database. These services may be connected to various resources and managed by a system operator.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments without departing from the spirit and scope of the described embodiments.

FIG. 1 is a block diagram that illustrates an example computing architecture, in accordance with some embodiments.

FIG. 2 is a component diagram of an example of a microservice architecture, in accordance with embodiments of the disclosure.

FIG. 3 is a component diagram of an example of a microservice architecture, in accordance with embodiments of the disclosure.

FIG. 4 is a flow diagram of a method of deploying a plugin extension with improved expressiveness in a repository, in accordance with some embodiments.

FIG. 5 is a flow diagram of a method of transmitting a listing of available plugin extensions to a client device, in accordance with some embodiments.

FIG. 6 is a block diagram of an example apparatus that may perform one or more of the operations described herein, in accordance with some embodiments of the present disclosure.

### DETAILED DESCRIPTION

Custom services, such as a containerized application for example, are deployed within a node or group of nodes (hereinafter, “cluster”) of a container-orchestration system (e.g., Redhat™ OpenShift™ module on a Kubernetes® platform) may depend on other services and their respective resources deployed within and outside the group. For example, a web service may persist its data into a resource, such as a database. The services may be deployed and connected to other services and resources by a cluster's system operator through a dependency configuration. These services and resources may be local to the operator, meaning already managed by the operator deploying the service, or may not be local and is a third-party resource managed by another operator. Some of these third-party resources may correspond to plugin extensions that add additional functionality to a service that may not be provided by resources that are local to the operator.

In a conventional container-orchestration system, operators may manage these third-party resources by defining custom resource definitions that describe the third-party resources and allowing for the creating, editing, and deletion of custom resources. The expressiveness of these custom resource operations (e.g., the creating, editing, and deleting of custom resources) is not user-friendly for advanced operations that include cluster queries. For example, in a conventional container-orchestration system there is no easy way to create a custom resource based on hardware features associated with a service. In the conventional-orchestration system, the plugin extension management mechanism is not connected to operators directly, leaving no native way to discover the existence of plugin extensions and bundle the plugin extensions into a container-orchestration system product.

Aspects of the disclosure address the above-noted and other deficiencies by adding expressiveness to plugin extensions using integration with operators. In embodiments, an operator developer may write a set of commands that corresponds to a plugin extension to be utilized by one or more services. The set of commands for the plugin extension may be added to an operator image that includes metadata identifying the plugin extension included in the operator image, adding expressiveness to the plugin extension. For example, the metadata may identify the plugin extension as a plugin extension that creates a performance profile for the cluster based on the hardware of the cluster. The operator image including the plugin extension and the metadata may be deployed in a repository with other operator images and subsequently used by services of the container-orchestration system.

When a user wishes to determine which plugin extensions are available to use, a client device of the user may transmit a query for available plugin extensions to the container-orchestration system. Upon receiving the query, processing logic of a processing device of a container-orchestration system may transmit a request to the repository for operator images that include plugin extensions. The processing logic may receive, from the repository, identifications of the operator images including the plugin extensions and the corresponding metadata for each of the operator images. The processing logic may be able to use the corresponding metadata to identify the types of plugin extensions that are included in each of the operator images. The processing logic may transmit a listing of the plugin extensions that are available to the client device.

By adding expressiveness to plugin extensions in a container-orchestration system, a user may be able to perform more advanced operations without having to generate their own set of commands for a plugin extension. The ability to query a container-orchestration system for available plugin extensions may provide a user access to various plugin extensions that have already been written by operator developers, reducing the potential for errors in the set of commands and improving the performance of the container-orchestration system.

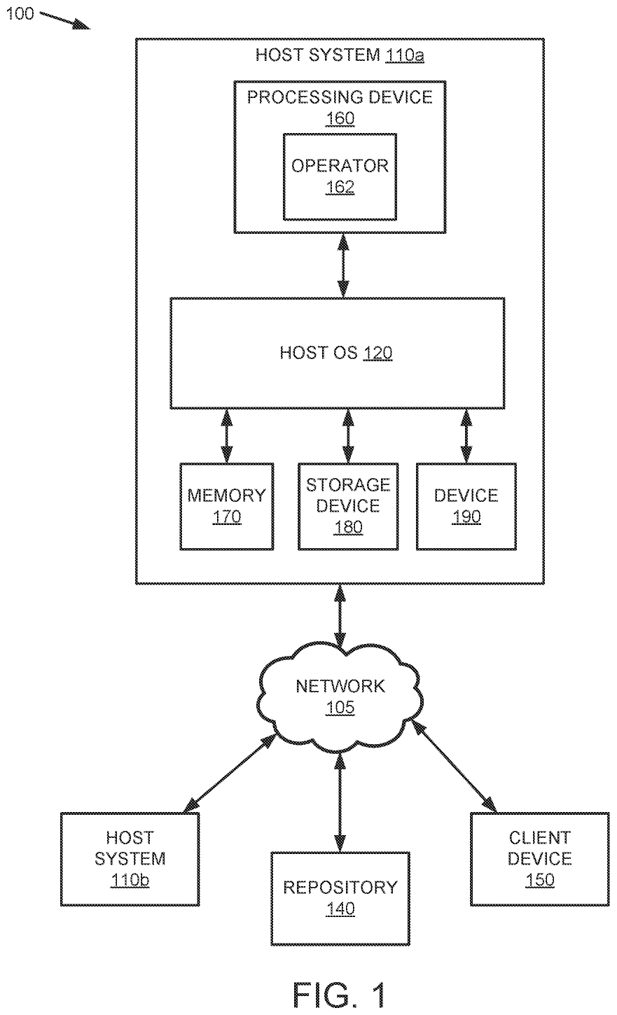

FIG. 1 depicts a high-level component diagram of an illustrative example of a microservice architecture 100, in accordance with one or more aspects of the present disclosure. However, other microservice architectures 100 are possible, and the implementation of a computer system utilizing examples of the disclosure are not necessarily limited to the specific architecture depicted by FIG. 1.

As shown in FIG. 1, microservice architecture 100 includes host systems 110a, b, repository 140, and client device 150. In embodiments, host systems 110a, b may correspond to nodes of a cluster, as previously described. The host systems 110a, b, repository 140, and client device 150 include one or more processing devices 160, memory 170, which may include volatile memory devices (e.g., random access memory (RAM)), non-volatile memory devices (e.g., flash memory) and/or other types of memory devices, a storage device 180 (e.g., one or more magnetic hard disk drives, a Peripheral Component Interconnect [PCI] solid state drive, a Redundant Array of Independent Disks [RAID] system, a network attached storage [NAS] array, etc.), and one or more devices 190 (e.g., a Peripheral Component Interconnect [PCI] device, network interface controller (NIC), a video card, an I/O device, etc.). In certain implementations, memory 170 may be non-uniform access (NUMA), such that memory access time depends on the memory location relative to processing device 160. It should be noted that although, for simplicity, a single processing device 160, storage device 180, and device 190 are depicted in FIG. 1, other embodiments of host systems 110a, b, repository 140, and client device 150 may include multiple processing devices, storage devices, or devices. Processing device 160 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 160 may also include one or more special-purpose processing devices such as an application specific integrated circuit (ASIC), a field programmable gate array (FPGA), a digital signal processor (DSP), network processor, or the like.

The host systems 110a, b, repository 140, and client device 150 may be a server, a mainframe, a workstation, a personal computer (PC), a mobile phone, a palm-sized computing device, etc. In embodiments, host systems 110a, b, repository 140, and/or client device 150 may be separate computing devices. In some embodiments, host systems 110a, b, repository 140, and/or client device 150 may be implemented by a single computing device. For clarity, some components of repository 140, host system 110b, and client device 150 are not shown. Although microservice architecture 100 is illustrated as having two host systems, embodiments of the disclosure may utilize any number of host systems.

Host systems 110a, b may additionally include a host operating system (OS) 120. Host OS 120 manages the hardware resources of the computer system and provides functions such as inter-process communication, scheduling, memory management, and so forth.

The host systems 110a, b, repository 140, and client device 150 are coupled to each other (e.g., may be operatively coupled, communicatively coupled, may communicate data/messages with each other) via network 105. Network 105 may be a public network (e.g., the internet), a private network (e.g., a local area network (LAN) or wide area network (WAN)), or a combination thereof. In one embodiment, network 105 may include a wired or a wireless infrastructure, which may be provided by one or more wireless communications systems, such as a WiFi™ hotspot connected with the network 105 and/or a wireless carrier system that can be implemented using various data processing equipment, communication towers (e.g., cell towers), etc. The network 105 may carry communications (e.g., data, message, packets, frames, etc.) between the various components of host systems 110a, b, repository 140, and/or client device 150.

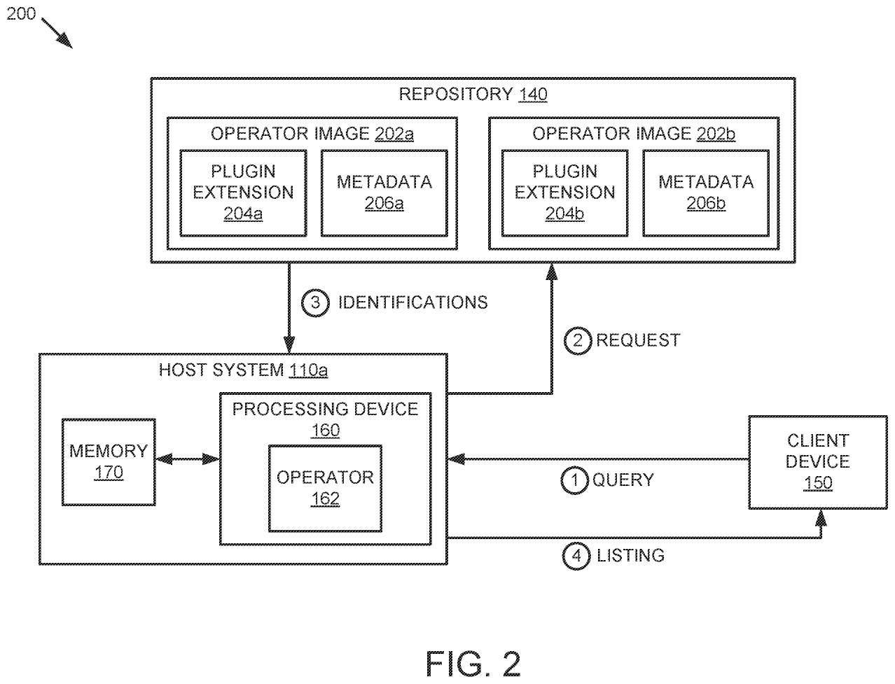

In embodiments, processing device 160 may execute an operator 162. As previously described, the operator 162 may make use of custom resources and manage applications and their components. The operator 162 may receive a query for available plugin extensions from client device 150. Upon receiving the query, the operator 162 may transmit a request to repository 140 for operator images that include plugin extensions. The operator 162 may receive the operator images including plugin extensions and metadata identifying the plugin extensions from the repository 140. The operator 162 may use the metadata to identify the types of plugin extensions included in the operator images. The operator 162 may further transmit a listing of the plugin extensions that are available to the client device 150. In embodiments, the operator 162 may be an index image that includes corresponding pointers to operator images stored at the repository 140. Further details regarding operator 162 will be discussed at FIGS. 2-5 below.

FIG. 2 is a component diagram of an example of a microservice architecture 200, in accordance with embodiments of the disclosure. The microservice architecture 200 includes host systems 110a, b, repository 140, client device 150, processing device 160, memory 170, and operator 162 of FIG. 1.

Repository 140 may include operator image 202a and operator image 202b that are stored in memory or at a storage device that is accessible by repository 140. Operator image 202a may include plugin extension 204a that corresponds to a set of commands to execute one or more operations and metadata 206a that identifies the plugin extension 204a. For example, plugin extension 204a may include a set of commands that creates a performance profile for a cluster based on the computing hardware of the cluster and metadata 206a may identify that plugin extension 204a creates a hardware-based performance profile for the cluster. Similarly, operator image 202b may include plugin extension 204b that includes a set of commands to execute one or more operations and metadata 206b that identifies the plugin extension 204b. In embodiments, operator image 202a and operator image 202b may be container images. In some embodiments, plugin extension 204a and/or plugin extension 204b may be binary plugins that are embedded into build script.

As previously described, when a user wishes to determine what plugin extensions are available to use, the client device 150 of the user may transmit a query requesting the available plugin extensions that can be used. Upon receiving the query, the operator 162 may transmit a request to the repository 140 for operator images that include plugin extensions that may be used by the client device 150. The operator 162 may then receive identifications of operator images stored at repository 140 that include plugin extensions, such as operator image 202a and operator image 202b. The operator 162 may also receive metadata 206a and metadata 206b that identify the types of plugin extensions (e.g., provide expressiveness) that are included in operator image 202a and operator image 202b, respectively. For example, metadata 206a may identify that the plugin extension 204a creates a performance profile based on hardware of a cluster, as previously described.

Upon receiving the identifications from the repository 140, the operator 162 may generate a listing of available plugin extensions and transmit the listing of available plugin extensions to the client device 150. In embodiments, the operator 162 may generate the listing of available plugin extensions using the metadata included in the operator images to identify the types of plugin extensions. For example, the operator 162 may use metadata 206a to determine that plugin extension 204a creates a performance profile based on the hardware of a cluster and generate a list of available plugin extensions that indicates one of the plugin extensions available (e.g., plugin extension 204a) creates a performance profile based on cluster hardware.

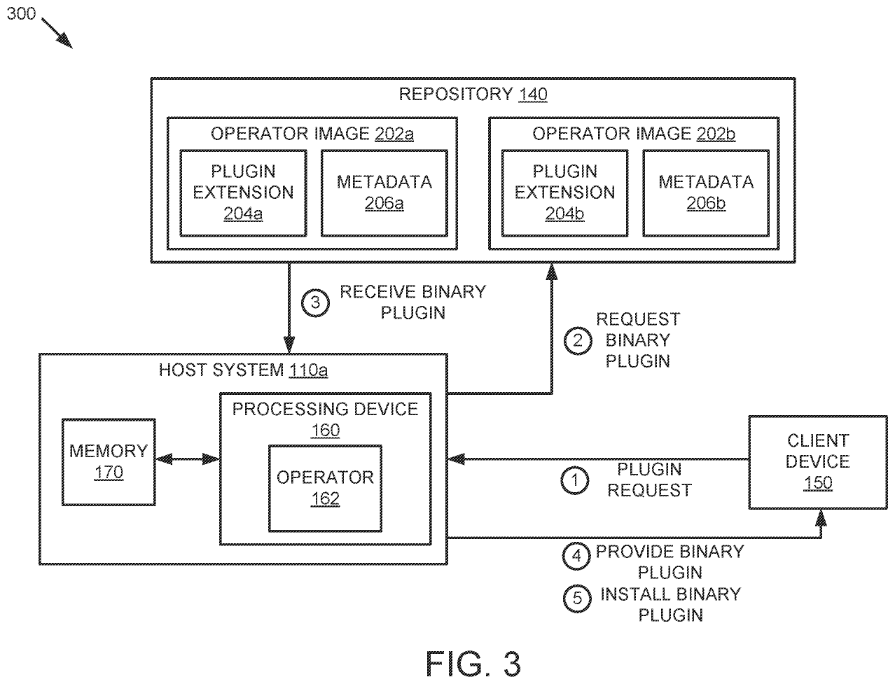

FIG. 3 is a component diagram of an example of a microservice architecture 300, in accordance with embodiments of the disclosure. The microservice architecture 300 includes host systems 110a, b, repository 140, client device 150, processing device 160, memory 170, and operator 162 of FIG. 1.

In FIG. 3, client device 150 has previously received a listing of available plugin extensions from operator 162, as previously described. Upon receiving the listing of available plugin extensions, the client device 150 may receive selections of one or more plugin extensions the client device 150 wishes to utilize. For example, the client device 150 may receive selections of one or more plugin extensions from a user of the client device 150.

Upon receiving the selections, the client device 150 may transmit a plugin request to the operator 162 that indicates the one or more plugin extensions to be utilized by the client device 150. For example, the plugin request may indicate that the client device 150 wishes to utilize plugin extension 204a included in operator image 202a. Upon receiving the request, the operator 162 may transmit a subsequent request for the binary plugin to the repository 140. The subsequent request may identify the operator image(s) associated with the plugin extensions that have been requested by the client device 150. For example, the subsequent request may identify operator image 202a, which includes plugin extension 204a that was identified by the plugin request transmitted by the client device 150. As previously described, in some embodiments the plugin extension(s) may be binary plugins.

Once the subsequent request has been transmitted to the repository 140, the operator 162 may receive the operator image(s) associated with the requested plugin extension(s). For example, the operator 162 may receive operator image 202a from the repository 140. The operator 162 may provide the operator image(s) to the client device 150 to enable the client device 150 to utilize the requested plugin extensions. For example, the operator 162 may provide operator image 202a to client device 150 to enable client device 150 to utilize plugin extension 204a. In some embodiments, providing the operator image to the client device 150 may cause the plugin extension to be installed locally on the client device 150. In embodiments, the plugin extension may be made available for use by the client device 150 when the client device 150 does not have internet access.

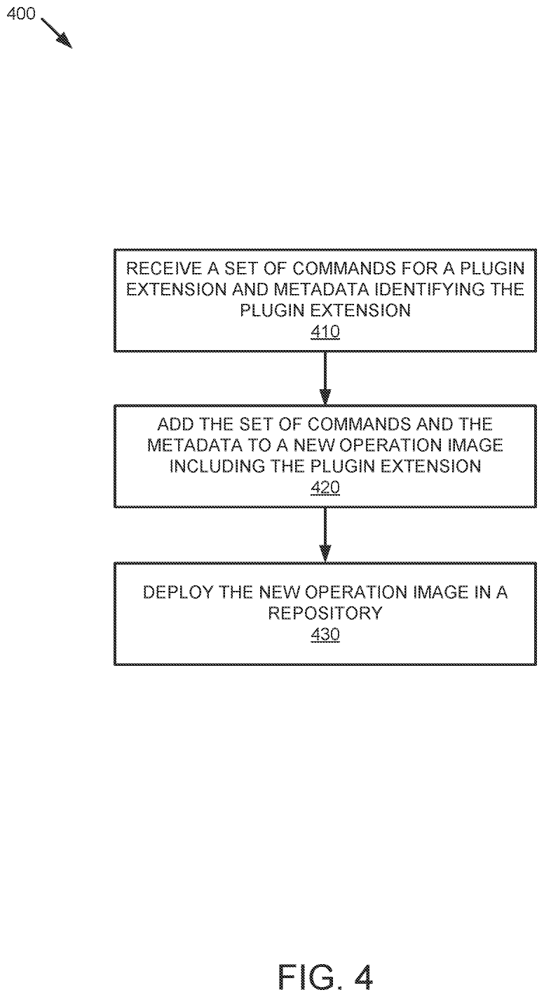

FIG. 4 is a flow diagram of a method 400 of deploying a plugin extension with improved expressiveness in a repository, in accordance with some embodiments. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed by operator 162 of FIG. 1.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

Method 400 begins at block 410, where the processing logic receives a set of commands for a plugin extension and metadata identifying the plugin extension. As previously described, an operator developer may write a set of commands that corresponds to a plugin extension to be utilized by one or more services. The operator developer may also provide metadata that provides information associated with the plugin extension. For example, the metadata may identify the plugin extension as a plugin extension that creates a performance profile for the cluster based on the hardware of the cluster.

At block 420, the processing logic adds the set of commands for the plugin extension to an operator image that includes the metadata identifying the plugin extension included in the operator image.

At block 430, the processing logic deploys the operator image including the plugin extension and the metadata in a repository with other operator images and that may be subsequently used by services of the container-orchestration system. In embodiments, the processing logic may deploy the operator image in a repository by storing the operator image in a memory or storage device that is accessible by the repository.

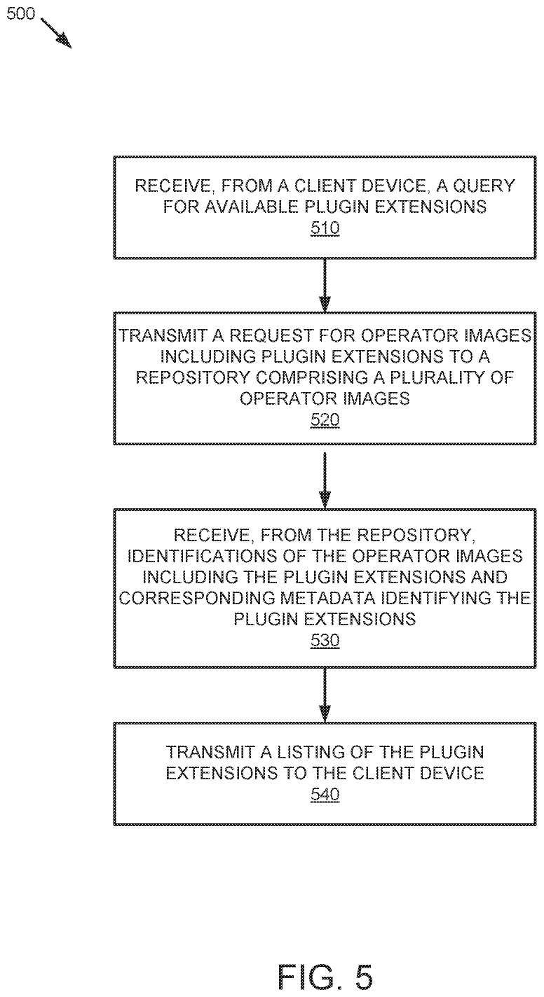

FIG. 5 is a flow diagram of a method 500 of transmitting a listing of available plugin extensions to a client device, in accordance with some embodiments. Method 500 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 500 may be performed by operator 162 of FIG. 1.

With reference to FIG. 5, method 500 illustrates example functions used by various embodiments. Although specific function blocks (“blocks”) are disclosed in method 500, such blocks are examples. That is, embodiments are well suited to performing various other blocks or variations of the blocks recited in method 500. It is appreciated that the blocks in method 500 may be performed in an order different than presented, and that not all of the blocks in method 500 may be performed.

Method 500 begins at block 510, where the processing logic receives a query for available plugin extensions from a client device.

At block 520, the processing logic transmits a request for operator images including plugin extensions to a repository that includes multiple operator images.

At block 530, the processing logic receives identifications of the operator images including the plugin extensions and corresponding metadata identifying the plugin extensions from the repository.

At block 540, the processing logic transmits a listing of the plugin extensions to the client device.

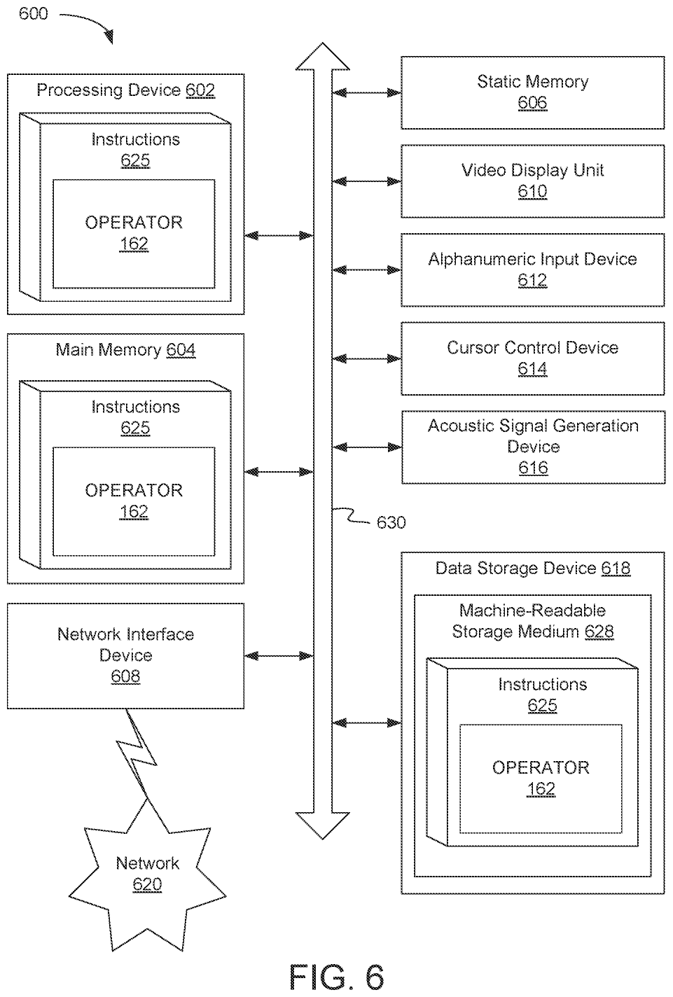

FIG. 6 is a block diagram of an example computing device 600 that may perform one or more of the operations described herein, in accordance with some embodiments. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device (e.g., a general purpose processor, a PLD, etc.) 602, a main memory 604 (e.g., synchronous dynamic random access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also comprise one or more special-purpose processing devices such as an application specific integrated circuit (ASIC), a field programmable gate array (FPGA), a digital signal processor (DSP), network processor, or the like. The processing device 602 may be configured to execute the operations described herein, in accordance with one or more aspects of the present disclosure, for performing the operations and steps discussed herein.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Data storage device 618 may include a computer-readable storage medium 628 on which may be stored one or more sets of instructions 625 that may include instructions for an operator, e.g., operator 162 for carrying out the operations described herein, in accordance with one or more aspects of the present disclosure. Instructions 625 may also reside, completely or at least partially, within main memory 604 and/or within processing device 602 during execution thereof by computing device 600, main memory 604 and processing device 602 also constituting computer-readable media. The instructions 625 may further be transmitted or received over a network 620 via network interface device 608.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “transmitting,” “adding,” “deploying,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

1. A method comprising:
receiving, from a client device, a query for available plugin extensions;
transmitting, by a processing device to a repository, a request for operator images that include plugin extensions, wherein the repository comprises one or more operator images, wherein each of the operator images comprises corresponding metadata identifying the plugin extensions of the operator images;
receiving, from the repository, identifications of the operator images including the plugin extensions and the corresponding metadata identifying the plugin extensions; and
transmitting a listing of the plugin extensions to the client device in response to the query, the listing of the plugin extensions generated based on the corresponding metadata.

2. The method of claim 1, further comprising:
receiving a set of commands for a plugin extension and metadata identifying the plugin extension;
adding the set of commands and the metadata to a new operator image including the plugin extension; and
deploying the new operator image in the repository.

3. The method of claim 1, wherein one or more of the plugin extensions comprise binary plugins.

4. The method of claim 1, further comprising:
receiving, from the client device, a subsequent request to utilize one or more of the plugin extensions from the listing of the plugin extensions;
acquiring the one or more of the plugin extensions from the repository; and
providing the one or more of the plugin extensions to the client device.

5. The method of claim 4, wherein providing the one or more of the plugin extensions to the client device causes the one or more of the plugin extensions to be installed locally on the client device.

6. The method of claim 1, wherein the processing device is executing an operator.

7. The method of claim 6, wherein the operator comprises an index image comprising corresponding pointers to the plurality of operator images of the repository.

8. A system comprising:
a memory; and
a processing device, operatively coupled to the memory, to:
receive, from a client device, a query for available plugin extensions;
transmit a request to a repository for operator images that include plugin extensions, wherein the repository comprises one or more operator images, wherein each of the operator images comprises corresponding metadata identifying the plugin extensions of the operator images;
receive, from the repository, identifications of the operator images including the plugin extensions and the corresponding metadata identifying the plugin extensions; and
transmit, to the client device in response to the query, a listing of the plugin extensions generated based on the corresponding metadata.

9. The system of claim 8, wherein the processing device is further to:
receive a set of commands for a plugin extension and metadata identifying the plugin extension;
add the set of commands and the metadata to a new operator image including the plugin extension; and
deploy the new operator image in the repository.

10. The system of claim 8, wherein one or more of the plugin extensions comprise binary plugins.

11. The system of claim 8, wherein the processing device is further to:
receive, from the client device, a subsequent request to utilize one or more of the plugin extensions from the listing of the plugin extensions;
acquire the one or more of the plugin extensions from the repository; and
provide the one or more of the plugin extensions to the client device.

12. The system of claim 11, wherein providing the one or more of the plugin extensions to the client device causes the one or more of the plugin extensions to be installed locally on the client device.

13. The system of claim 8, wherein the processing device is executing an operator.

14. The system of claim 13, wherein the operator comprises an index image comprising corresponding pointers to the plurality of operator images of the repository.

15. A non-transitory computer-readable storage medium including instructions that, when executed by a processing device, cause the processing device to:
receive, from a client device, a query for available plugin extensions;
transmit, by the processing device to a repository, a request for operator images that include plugin extensions, wherein the repository comprises one or more operator images, wherein each of the operator images comprises corresponding metadata identifying the plugin extensions of the operator images;
receive, from the repository, identifications of the operator images including the plugin extensions and the corresponding metadata identifying the plugin extensions; and
transmit, to the client device in response to the query, a listing of the plugin extensions generated based on the corresponding metadata.

16. The non-transitory computer-readable storage medium of claim 15, wherein the processing device is further to:
receive a set of commands for a plugin extension and metadata identifying the plugin extension;
add the set of commands and the metadata to a new operator image including the plugin extension; and
deploy the new operator image in the repository.

17. The non-transitory computer-readable storage medium of claim 15, wherein one or more of the plugin extensions comprise binary plugins.

18. The non-transitory computer-readable storage medium of claim 15, wherein the processing device is further to:
receive, from the client device, a subsequent request to utilize one or more of the plugin extensions from the listing of the plugin extensions;
acquire the one or more of the plugin extensions from the repository; and
provide the one or more of the plugin extensions to the client device.

19. The non-transitory computer-readable storage medium of claim 18, wherein providing the one or more of the plugin extensions to the client device causes the one or more of the plugin extensions to be installed locally on the client device.

20. The non-transitory computer-readable storage medium of claim 15, wherein the processing device is executing an operator.
